(19) United States
(12) Patent Application Publication
(10) Pub. No.: US 2015/0212545 A1
(43) Pub. Date: Jul. 30, 2015

(54) Extendable Computer Touchpad Screen

(71) Applicant: Yitao Ding, Beijing (CN)

(72) Inventor: Yitao Ding, Beijing (CN)

(21) Appl. No.: 14/493,329

(22) Filed: Sep. 22, 2014

Related U.S. Application Data
(60) Provisional application No. 61/931,992, filed on Jan. 27, 2014.

(51) Int. Cl. G06F 1/16; G06F 3/0488; G06F 3/041; G06F 3/02; G06F 3/044

(52) U.S. Cl. CPC G06F 1/1647; G06F 3/0227; G06F 3/044; G06F 3/0412; G06F 3/04886; G06F 1/1616; G06F 1/1662; G06F 1/1643

(57) ABSTRACT

A laptop computer configured for a secondary touch screen comprises a segmented base and includes a keyboard segment adjacent a front edge of the computer base and a secondary base segment adjacent a back edge of the keyboard segment. A primary hinge assembly on a back edge of the secondary base segment is configured to enable the secondary base segment to hingedly connect at an angle to a primary screen. A secondary hinge assembly is disposed between the back edge of the computer base and a front edge of the secondary base segment. The secondary hinge assembly enables the secondary base segment to hingedly connect at an angle to the keyboard segment. A secondary touch screen is connected to the secondary base which is configured to have similar electronic characteristics to the primary screen and be in communication with the keyboard segment via the secondary hinge assembly.

### CROSS-REFERENCE TO RELATED APPLICATIONS

This application claims the benefit of the priority date of earlier filed U.S. Provisional Utility Application Ser. No. 61/931,992 filed Jan. 27, 2014 for Yitao Ding, incorporated herein by reference in its entirety.

### BACKGROUND AND FIELD OF INVENTION

Laptop computers emerged to address the need for mobile computing capabilities, particularly when away from home, work, or school. Traditional laptop computers generally feature a display screen that is attached via a hinge to a compact keyboard that is designed specifically for use with a laptop computer. Laptop computer hardware typically comprises miniaturized versions of desktop computer hardware that is housed within the laptop compartment underneath the keyboard.

Laptop computers very often incorporate the same hardware that is found in their desktop counterparts. For example, laptop computers may comprise an optical disk drive (size-permitting), speakers, one or more Universal Serial Bus (USB) ports, an Ethernet port, and a display port. Laptops are powered via rechargeable batteries or by providing electrical power through the use of an alternating current (AC) adapter.

A laptop computer comprises a primary display screen and base with keyboard. The base of the laptop houses the laptop computer hardware in a conventional clamshell design. The clamshell design of the laptop computer incorporates a hinge mechanism that allows the primary display screen to rotate about the hinge in order to open and close the laptop computer.

In addition to the keyboard, user input to a laptop computer is provided through the use of a small touchpad that serves essentially the same function as that of a computer mouse. In most conventional laptop computer designs, the touchpad is typically present directly beneath the keyboard near the front edge of the computer for convenient access during use.

There is a long felt need for a device and method to enhance and improve upon conventional laptop computer design that has gone unmet until the present Applicants' disclosure.

### SUMMARY OF THE INVENTION

A laptop computer configured for a secondary touch screen comprises a segmented base and includes a keyboard segment adjacent a front-edge of the computer base and a secondary base segment adjacent a back edge of the keyboard segment. A primary hinge assembly on a back edge of the secondary base segment is configured to enable the secondary base segment to hingedly connect at an angle to a primary screen. A secondary hinge assembly is disposed between the back edge of the computer base and a front edge of the secondary base segment. The secondary hinge assembly enables the secondary base segment to hingedly connect at an angle to the keyboard segment. A secondary touch screen is connected to the secondary base which is configured to have similar electronic characteristics to the primary screen and be in communication with the keyboard segment via the secondary hinge assembly.

A method for making a secondary screen on a laptop computer is also disclosed. The method includes providing a segmented base comprising a keyboard segment adjacent a front edge of the computer base and a secondary base segment adjacent a back edge of the keyboard segment and a primary hinge assembly on a back edge of the secondary base segment configured to enable the secondary base segment to hingedly connect at an angle to a primary screen. The method also includes providing a secondary hinge assembly disposed between the back edge of the computer base and a front edge of the secondary base segment, the secondary hinge assembly configured to enable the secondary base segment to hingedly connect at an angle to the keyboard segment. The method further includes providing a secondary screen disposed on the secondary base, the secondary screen configured to have similar electronic characteristics to the primary screen and be in communication with the keyboard segment via the secondary hinge assembly.

A method for processing input and output of a secondary screen on a laptop computer is also disclosed. The method includes configuring a different screen content between the primary screen and the secondary screen. The method also includes configuring a display on the secondary screen including information defined by a separate application program to an application program displayed on the primary screen. The method additionally includes providing a display on the secondary screen including supplemental information to a user of the laptop and the primary screen including a map of an in-game environment and an inventory of a player's in-game character. The method further comprises providing an extended screen touch and capacitive input including both the primary screen and the secondary screen. The method yet includes providing a multiplexed screen input between the primary screen and the secondary screen depending on the application and user's needs.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is an isometric view of the laptop computer with an extendable secondary touchpad screen in accordance with an embodiment of the present disclosure.

FIG. 2 is an alternate isometric view of the laptop computer with an extendable secondary touchpad screen in accordance with an embodiment of the present disclosure.

FIG. 3 is a top view of the laptop computer with an extendable secondary touchpad screen in accordance with an embodiment of the present disclosure.

FIG. 4 is a right side view of the laptop computer with an extendable secondary touchpad screen in accordance with an embodiment of the present disclosure.

FIG. 5 is a left side view the laptop computer with an extendable secondary touchpad screen in accordance with an embodiment of the present disclosure.

FIG. 6 is a top view of the laptop computer with an extendable secondary touchpad screen display output across both display screens in accordance with an embodiment of the present disclosure.

FIG. 7 is a top view of the laptop computer with an extendable secondary touchpad screen displaying two different outputs on the primary display screen and the secondary display screen in accordance with an embodiment of the present disclosure.

FIG. 8 is a right side view of the laptop computer with an extended and angled secondary touchpad screen in accordance with an embodiment of the present disclosure.

FIG. 9 is a block diagram of a method for extending a secondary touchpad screen on a laptop computer in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, use of the term ‘screen’ refers to an output display component of a computer including both touch screens and conventional display screens. Therefore, a primary screen may comprise a conventional display and a secondary screen may include a touch screen comprising a touch sensitive or capacitive sensing input screen component.

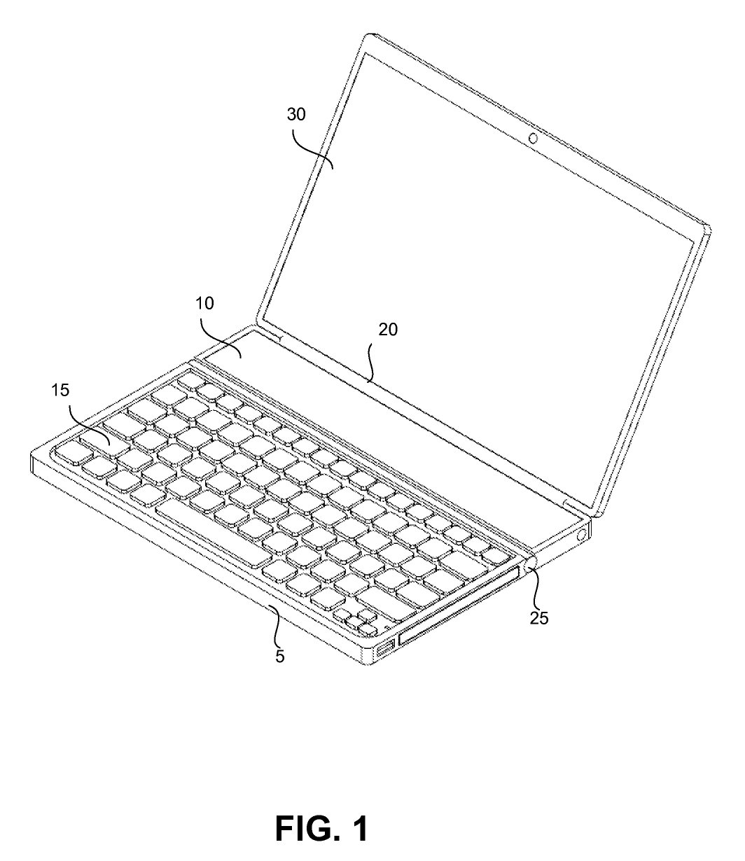

FIG. 1 is an isometric view of the laptop computer with an extendable secondary touchpad screen in accordance with an embodiment of the present disclosure. The present invention is a laptop computer featuring a segmented base 5 and a secondary display screen 10 that serves as both a display and a touch input device. Unlike traditional laptop computers, the laptop computer of the present invention does not include a conventional trackpad. The keyboard 15 of the laptop computer is situated towards the edge of the laptop computer base 5 away from the primary hinge 20. The remaining surface area of the laptop computer base comprises a secondary display screen 10 positioned adjacent to the laptop computer hinge 20.

The secondary display screen 10 and corresponding laptop computer base portion are joined to a secondary hinge 25 that allows a user to orient the secondary screen 10 and base 5 from a flat position to an angled position. The secondary display screen 10 serves a multitude of roles throughout normal use of the laptop computer. Because of its proximity to the hinge 20 of the laptop computer, the secondary display screen 10 may serve as a concatenated extension of the primary display screen with the visual feed of the laptop computer output extended across the two display screens.

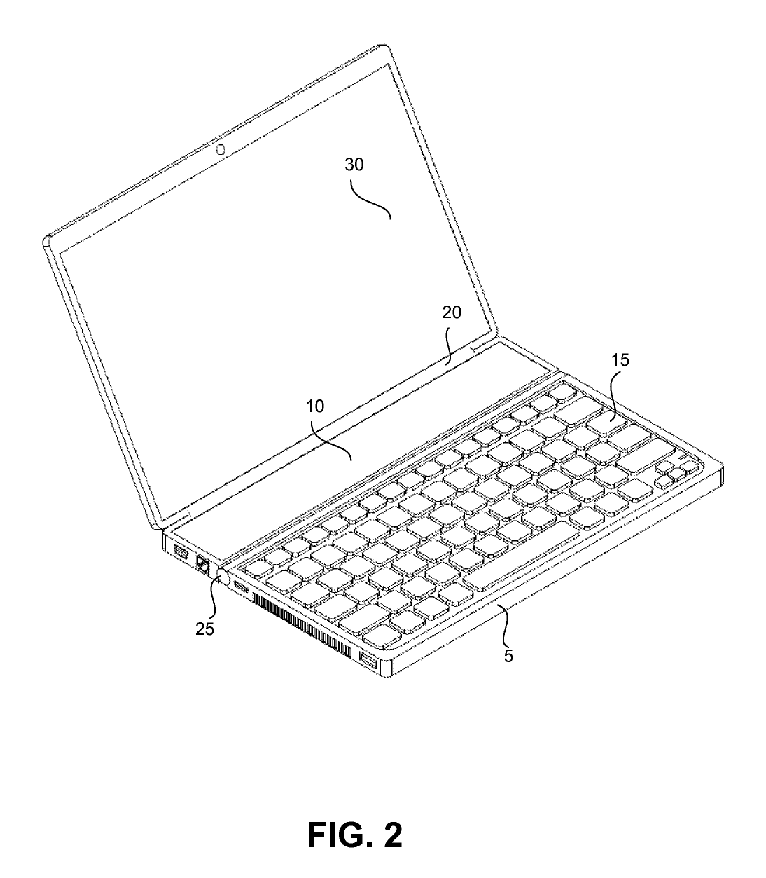

FIG. 2 is an alternate isometric view of the laptop computer with an extendable secondary touchpad screen in accordance with an embodiment of the present disclosure. Same and similar features may be referred to with same reference numbers depicted on other figures. The secondary display screen 10 may be utilized as a user touch input device similar to the primary display screen 30. Finally, the secondary display screen 10 may be utilized for a display output that differs from that of the primary display screen 30. An example application of this final role of the secondary display screen 10 is to display supplemental information to a user who is playing a video game on the laptop.

For example, in this application, the primary display screen 30 may be utilized by the player to navigate an in-game environment while the secondary display screen 10 is utilized to display useful information such as a map of the in-game environment or the inventory of the player's in-game character. Touch input capability of the secondary display screen 10 is maintained throughout the various roles that may be occupied by the secondary display screen 10.

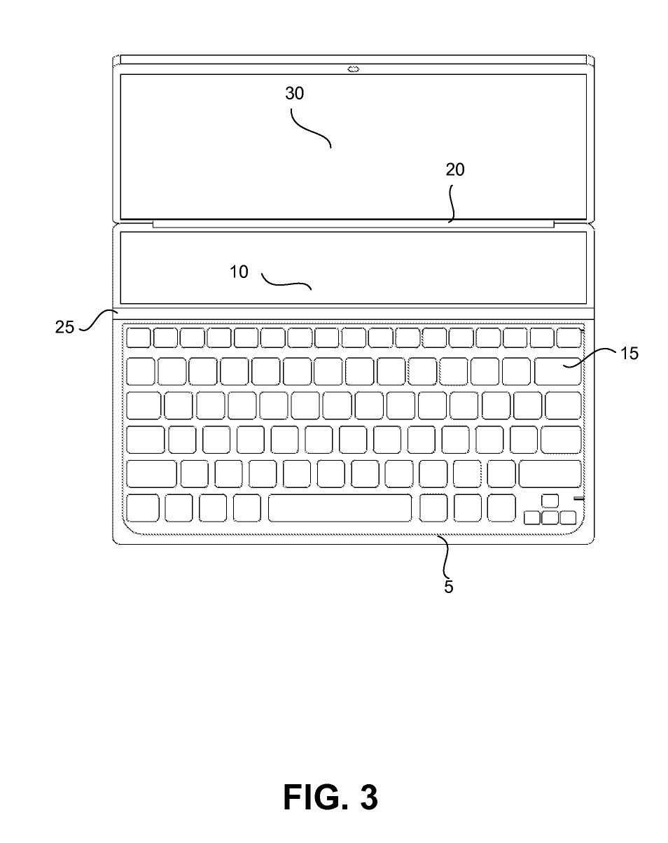

FIG. 3 is a top view of the laptop computer with an extendable secondary touchpad screen in accordance with an embodiment of the present disclosure. Same and similar features may be referred to with same reference numbers depicted on other figures. The present invention is a laptop computer that features a secondary display screen 10 that is capable of both display output and touch input. The laptop computer comprises a design that deviates from that of conventional laptop computers in terms of both user input and display output. However, in the preferred embodiment of the present invention, the laptop computer comprises the conventional clamshell design shared by a large number of laptop computers.

The laptop computer comprises a display housing, a top shell, a hinge assembly, a base, a bottom shell, computer hardware, and a plurality of ports. The display housing of the laptop computer comprises a rectangular frame that is capable of accommodating and holding a display panel of the primary display screen securely in place. The laptop computer primary display screen may comprise a liquid-crystal display (LCD), a light emitting diode (LED) display, an organic LED (OLED) display, and displays utilizing additional types of technology. The primary display screen is capable of providing a visual display as well as user touch input through the screen. The top shell of the laptop computer covers the rear surface of the primary display screen and the rectangular frame of the display housing. The design of the visible exterior of the top shell may be cosmetically altered to the user's preference. In various embodiments of the present invention, the display housing may comprise an interior embedded camera as well. Additionally, the display housing comprises a mounting point for securing the display housing to the hinge assembly of the laptop computer.

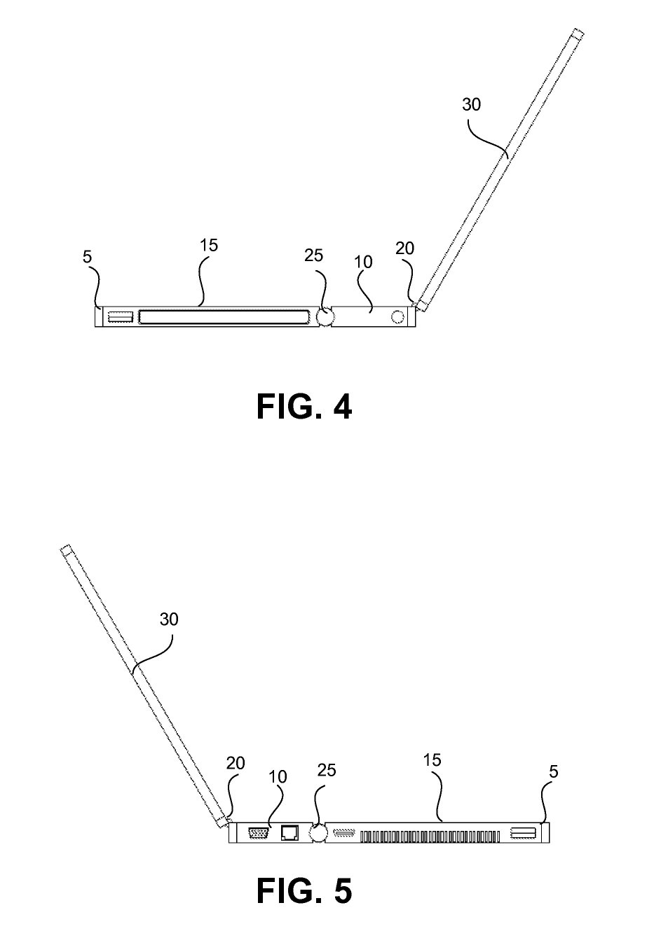

FIG. 4 is a right side view of the laptop computer with an extendable secondary touchpad screen in accordance with an embodiment of the present disclosure. Same and similar features may be referred to with same reference numbers depicted on other figures. The display housing of the laptop computer is joined to the base of the laptop computer via a hinge assembly 20. In the preferred embodiment of the present invention, the hinge assembly 20 may comprise one or more hinges and/or mechanical connectors as well as one or more electrical connectors, wires and cables. Various embodiments of the present invention may include a different hinge assembly that allows the primary display screen to spatially rotate, pivot, pivotally move, pivotally rotate, and close onto the base of the laptop computer. Electrical connectors of the hinge assembly allow connection between the primary display screen 30 and computer hardware within the segmented base 5 of the laptop computer. The electrical connectors may be utilized to transfer data and control signals between the primary display screen 30 and the computer hardware as well as to provide power to the primary display screen 30 and the secondary touchpad display 20.

A width dimension of the secondary touchpad screen is configured to match a width dimension of the primary display screen in an embodiment of the present disclosure. Also, a height dimension of the secondary screen is configured to be between one fourth and one fifth a height of the primary display screen inclusive and a total screen area of the secondary screen to be between 20% and 70% the area of the primary screen.

FIG. 5 is a left side view the laptop computer with an extendable secondary touchpad screen in accordance with an embodiment of the present disclosure. Same and similar features may be referred to with same reference numbers depicted on other figures. In an embodiment of the present disclosure, the segmented base 5 of the laptop computer comprises an upper surface and a lower surface. The upper surface of the laptop computer base comprises a mounting point for securing the base to the hinge assembly of the laptop computer as well as a physical keyboard 15. The keyboard 15 is situated towards a front edge of the laptop computer base 5 opposite that of the hinge assembly 20 mounting point at a back edge of the computer base. This configuration places the keyboard 15 directly at the edge of the laptop computer base in closer proximity to a user than in conventional keyboards.

The keyboard 15 is contained within an indented trough that provides sufficient clearance for the keyboard 15 when the laptop computer is closed. The remaining upper surface region of the laptop computer base comprises the secondary display screen 10. The secondary display screen 10 is situated in close proximity adjacent the hinge assembly 20 and 25 as well as the primary display screen 30. As with the primary display screen 30 of the laptop computer, the secondary display screen 10 may comprise an LCD, LED, OLED, or additional type of display. Additionally, the secondary display screen 10 is capable of both visual display as well as user touch input through the screen. The secondary display screen 10 is joined to a secondary hinge 25 that allows a user to orient the secondary display screen 10 and corresponding laptop computer base 5 portion from a flat position to an angled position. The segmented base 5 of the laptop computer may not include a conventional trackpad normally present on laptop computers for user touch input.

The bottom shell encloses the lower surface of the laptop computer base. The laptop computer hardware is contained within the base and bottom shell of the laptop computer. In the preferred embodiment of the present invention, the laptop computer comprises conventional hardware that is commonly found in a laptop computer. The laptop computer may comprise computer hardware including, but not limited to, a central processing unit (CPU), a heatsink/fan/cooling system, a rechargeable battery, a motherboard, random-access memory (RAM), a graphics processing unit (GPU), one or more storage devices, and an optical disk drive. The laptop computer may further comprise additional features including, but not limited to, speakers, one or more USB ports, an Ethernet port, a display port, vents, and a charging port. The laptop computer may draw power from an external source through the use of an AC adapter or similar device.

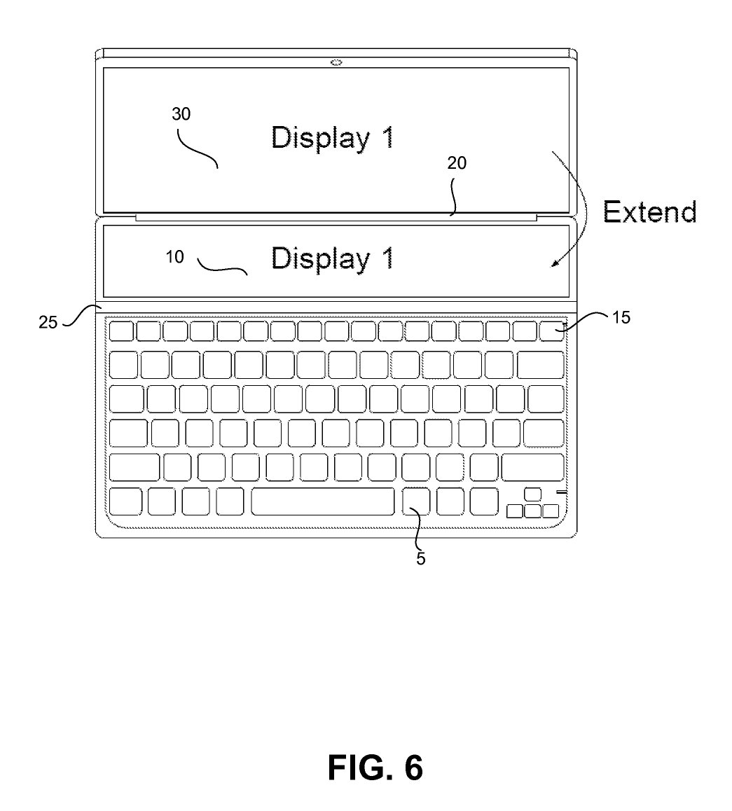

FIG. 6 is a top view of the laptop computer with an extendable secondary touchpad screen display output across both display screens in accordance with an embodiment of the present disclosure. Same and similar features may be referred to with same reference numbers depicted on other figures. As previously discussed, the secondary display screen 10 of the laptop computer is situated in close proximity to the primary display screen 30. In the preferred embodiment of the present invention, the secondary display screen 10 is capable of fulfilling a number of roles during use of the laptop computer. As shown in FIG. 6, a user may extend the visual feed of the laptop computer from the primary display screen 30 to the secondary display screen 10. In this manner, the secondary display screen 10 serves as an extension of the primary display screen 30 with the visual feed output extended across the two display screens.

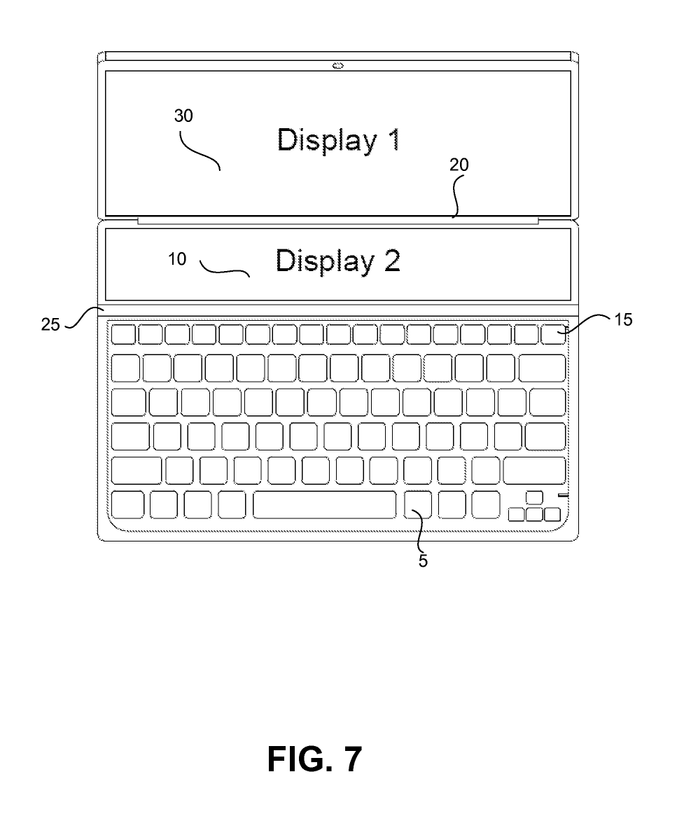

FIG. 7 is a top view of the laptop computer with an extendable secondary touchpad screen displaying two different outputs on the primary display screen and the secondary display screen in accordance with an embodiment of the present disclosure. Same and similar features may be referred to with same reference numbers depicted on other figures. The secondary screen 10 content may be concatenated to the end of the primary screen 30 content. The secondary display screen 10 may also be utilized to display a separate visual feed from that of the primary display screen 30 as shown. Regardless of whether the secondary display screen 10 is utilized as an extension or a separate display device, a user may provide touch input through both the primary display screen 30 and the secondary display screen 10. As such, the secondary display screen 10 may fulfill the role traditionally occupied by trackpads.

In another embodiment of the disclosure, a display on the secondary screen included information defined by a separate application program to an application program displayed on the primary screen. The embodiment may also include a multiplexed screen input between the primary screen and the secondary screen. Furthermore, a keyboard segment of the segmented base comprises one of a physical keyboard and a virtual keyboard configured to display a keyboard and accept input as a keyboard.

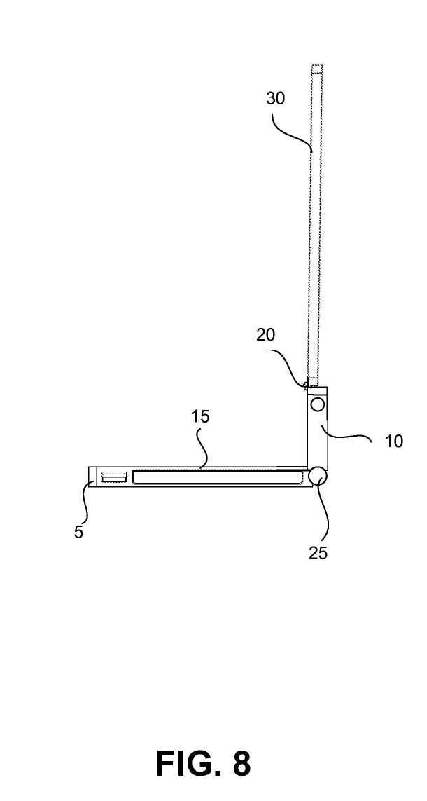

FIG. 8 is a right side view of the laptop computer with an extended and angled secondary touchpad screen in accordance with an embodiment of the present disclosure. Same and similar features may be referred to with same reference numbers depicted on other figures. As previously discussed, the secondary hinge 25 of the secondary display screen 10 allows a user to orient the secondary display screen 10 and corresponding laptop computer base portion from a flat position to an angled position. A 90 degree position is depicted with respect to the segmented base 5 but other positions between zero degrees and 90 degrees are also included in the embodiment.

In an embodiment of the disclosure, an angle of connection between the keyboard segment and the secondary base segment comprises any angle between 180 degrees and 90 degrees. An angle of connection between the secondary base segment and the primary screen comprises any angle between 180 degrees and zero degrees. As a result of an angled secondary touchpad screen 10, an extended height of the primary screen in relation to an extended secondary base segment and the segmented base is achieved. Among other advantages heretofore discussed, the extended height brings the primary screen closer to a user's view.

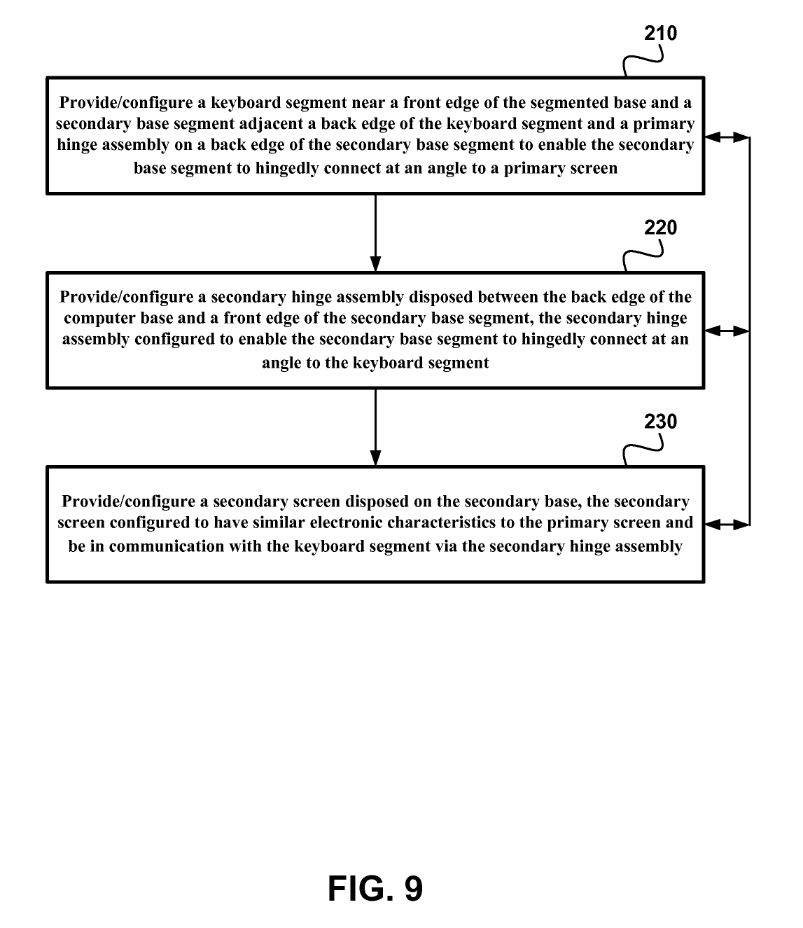

FIG. 9 is a block diagram of a method for extending a secondary touchpad screen on a laptop computer in accordance with an embodiment of the present disclosure. The method includes 210 providing a segmented base comprising a keyboard segment adjacent a front edge of the computer base and a secondary base segment adjacent a back edge of the keyboard segment and a primary hinge assembly on a back edge of the secondary base segment configured to enable the secondary base segment to hingedly connect at an angle to a primary screen. The method also includes 220 providing a secondary hinge assembly disposed between the back edge of the computer base and a front edge of the secondary base segment, the secondary hinge assembly configured to enable the secondary base segment to hingedly connect at an angle to the keyboard segment. The method further includes 230 providing a secondary screen disposed on the secondary base, the secondary screen configured to have similar electronic characteristics to the primary screen and be in communication with the keyboard segment via the secondary hinge assembly.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A laptop computer with a secondary screen comprising:
a segmented base comprising a keyboard segment adjacent a front edge of the computer base and a secondary base segment adjacent a back edge of the keyboard segment and a primary hinge assembly on a back edge of the secondary base segment configured to enable the secondary base segment to hingedly connect at an angle to a primary screen;
a secondary hinge assembly disposed between the back edge of the computer base and a front edge of the secondary base segment, the secondary hinge assembly configured to enable the secondary base segment to hingedly connect at an angle to the keyboard segment; and
a secondary screen disposed on the secondary base, the secondary screen configured to have similar electronic characteristics to the primary screen and be in communication with the keyboard segment via the secondary hinge assembly.

2. The laptop computer with a secondary screen of claim 1, wherein a width dimension of the secondary screen is configured to match a width dimension of the primary screen.

3. The laptop computer with a secondary screen of claim 1, wherein a height dimension of the secondary screen is configured to be between one fourth and one fifth a height of the primary screen inclusive.

4. The laptop computer with a secondary screen of claim 1, wherein the angle of connection between the keyboard segment and the secondary base segment comprises any angle between 180 degrees and 90 degrees.

5. The laptop computer with a secondary screen of claim 1, wherein the angle of connection between the secondary base segment and the primary screen comprises any angle between 180 degrees and zero degrees.

6. The laptop computer with a secondary screen of claim 1, wherein the electronic characteristics of the primary screen and the similar electronic characteristics of the secondary screen comprise touch and capacitive sensitive input and an output display.

7. The laptop computer configuration with a secondary screen of claim 1, further comprising an extended screen content between the primary screen and the secondary screen.

8. The laptop computer with a secondary screen of claim 1, further comprising a different screen content between the primary screen and the secondary screen.

9. The laptop computer with a secondary screen of claim 1, further comprising a display on the secondary screen including information defined by a separate application program in relation to an application program displayed on the primary screen.

10. The laptop computer with a secondary screen of claim 1, further comprising a display on the secondary screen including supplemental information to a user of the segmented base and the primary screen including a map of an in-game environment and an inventory of a player's in-game character.

11. The laptop computer with a secondary screen of claim 1, further comprising an extended screen touch and capacitive input including both the primary screen and the secondary screen.

12. The laptop computer with a secondary screen of claim 1, further comprising a multiplexed screen input between the primary screen and the secondary screen.

13. The laptop computer with a secondary screen of claim 1, further comprising an extended height of the primary screen in relation to an extended secondary base segment and the segmented base, the extended height configured to bring the primary screen closer to a user's view.

14. The laptop computer with a secondary screen of claim 1, wherein each hinge assembly comprises electrical connectors, cables and wires to enable each respective hinge to communicate with a plurality of components on either side of the respective hinge.

15. The laptop computer with a secondary screen of claim 1, wherein the keyboard segment of the segmented base comprises one of a physical keyboard and a virtual keyboard configured to display a keyboard and accept input as a keyboard.

16. A method for making a secondary screen on a laptop computer, the method comprising:
providing a segmented base comprising a keyboard segment adjacent a front edge of the computer base and a secondary base segment adjacent a back edge of the keyboard segment and a primary hinge assembly on a back edge of the secondary base segment configured to enable the secondary base segment to hingedly connect at an angle to a primary screen;
providing a secondary hinge assembly disposed between the back edge of the computer base and a front edge of the secondary base segment, the secondary hinge assembly configured to enable the secondary base segment to hingedly connect at an angle to the keyboard segment; and
providing a secondary screen disposed on the secondary base, the secondary screen configured to have similar electronic characteristics to the primary screen and be in communication with the keyboard segment via the secondary hinge assembly.

17. The method for making a secondary screen on a laptop computer of claim 16, wherein a width dimension of the secondary screen is configured to match a width dimension of the primary screen and a height dimension of the secondary screen is configured to be between one fourth and one fifth a height of the primary screen inclusive and a total screen area of the secondary screen to be between 20% and 70% the area of the primary screen.

18. A method for processing input and output of a secondary screen on a laptop computer, the method comprising:
configuring a segmented base comprising a keyboard segment adjacent a front edge of the computer base and a secondary base segment adjacent a back edge of the keyboard segment and a primary hinge assembly on a back edge of the secondary base segment configured to enable the secondary base segment to hingedly connect at an angle to a primary screen;
configuring a secondary hinge assembly disposed between the back edge of the computer base and a front edge of the secondary base segment, the secondary hinge assembly configured to enable the secondary base segment to hingedly connect at an angle to the keyboard segment; and
configuring a secondary screen disposed on the secondary base, the secondary screen configured to have similar electronic characteristics to the primary screen and be in communication with the keyboard segment via the secondary hinge assembly.

19. The method for processing input and output of a secondary screen on a laptop computer of claim 1, further comprising extending a screen content by concatenating the primary screen and the secondary screen.

20. The method for processing input and output of a secondary screen on a laptop computer of claim 1, further comprising differentiating a screen content between the primary screen and the secondary screen.
